(19) United States
(12) Patent Application Publication
(10) Pub. No.: US 2015/0174486 A1
(43) Pub. Date: Jun. 25, 2015

(54) METHOD FOR AN ASYNCHRONOUS MULTIPLAYER GAMEPLAY

(71) Applicant: FORM AND PATTERN LLC, Los Angeles, CA (US)

(72) Inventor: Roni Brunn, Beverly Hills, CA (US)

(73) Assignee: FORM AND PATTERN LLC, Los Angeles, CA (US)

(21) Appl. No.: 14/139,499

(22) Filed: Dec. 23, 2013

(51) Int. Cl. A63F 13/35; A63F 13/70

(52) U.S. Cl. CPC A63F 13/35; A63F 13/70

(57) ABSTRACT

A method for an asynchronous multiplayer gameplay. The method may comprise the computer-implemented steps of: providing a computer with a social media application configured to allow a first user to be followed by one or more second users; creating a challenge by the first user using the social media application; displaying that challenge in a feed by the social media application; receiving one or more inputs from a second user in response to the challenge; calculating a score based on the input of the second user; and displaying the score of the challenge. The challenge may be a trivia game such as a music video trivia game and may further comprise a rating system and a system for gathering popularity data.

### FIELD OF INVENTION

The present disclosure relates to computer-implemented methods and systems for multiplayer asynchronous gameplay, and, more particularly, to software applications that provide a feed containing challenges to an undefined number of players over an undefined period of time.

### BACKGROUND

Videogames have evolved significantly throughout the years. For example, a videogame would typically be played by a single player on a single device or by multiple players on a single device. Examples of such single player games may include Solitaire, Tetris®, and Angry Birds®. Examples of two player games, on the other hand, may include Words With Friends® and Letterpress. Although multiplayer games such as Scrabble® and Risk® may comprise more than two players, such games are usually limited to no more than four players.

In recent years, however, massively multiplayer online (MMO) games have gained popularity due to their capability of supporting a large number of players. However, these MMO games such as Happy Farm and World of Warcraft® are generally subject to several gameplay limitations. For example, MMOs usually require a synchronous gameplay environment (i.e., requiring simultaneous gameplay among players in a single “world”) or embody a timed tournament that ends concurrently for all players. Additionally, only those players participating in the game itself are usually allowed to play, as opposed to non-players or spectators who merely observe the game.

Another restriction for conventional games is that most games generally do not provide opponent feedback for a challenge created by a player. Although certain games allow players to send chat messages to their opponents to assess or comment on their moves, most players are unable to obtain feedback for challenges that he or she created. Thus, players faced with a new game challenge are generally left without knowledge about the difficulty of a particular game.

Therefore, what is needed is a multiplayer gameplay that resolves the foregoing deficiencies. Preferably, the new gameplay may be played asynchronously among an infinite number of players and may be configured to allow various players such as non-players and spectators to participate in the same game challenges. Furthermore, the game may also provide a rating and feedback system that would be able to provide useful information about a particular game challenge.

### SUMMARY OF THE INVENTION

To minimize the limitations in the prior art, and to minimize other limitations that will become apparent upon reading and understanding the present specification, the foregoing discloses a new and useful asynchronous multiplayer gameplay.

One embodiment may be a method for an asynchronous multiplayer gameplay, comprising: providing a first computer, at least one second computer, and at least one server; wherein the first computer comprises a social media application for a first user; wherein the at least one second computer comprises the social media application for at least one second user; wherein the social media application is configured to allow the first user to be followed by the at least one second user; creating one or more challenges on the social media application by the first user; wherein the one or more challenges are stored in the at least one server; transmitting a feed containing at least one of the one or more challenges to the at least one second computer by the at least one server; displaying the feed to the at least one second user by the social media application; wherein the one or more challenges are configured to receive one or more inputs from the at least one second user; receiving the one or more inputs from the at least one second user asynchronously by the social media application to create an input data; storing the input data into the at least one server; and calculating one or more scores based on the input data. The one or more challenges may be one or more music video trivia questions that are part of a music video trivia game. The input data may comprise a popularity data; and wherein the popularity data may be configured to indicate a popularity of the one or more music videos of the music video trivia game. The social media application may be configured to allow the at least one second user to provide one or more approvals for the one or more music videos. The calculation of each of the one or more scores may be inversely proportional to a time period lapsed to correctly answer the one or more challenges. Each of the one or more scores may be compared and displayed to the first user and the at least one second user. The method may further comprise: a rating system; wherein the rating system may be configured to solicit one or more ratings from the at least one second user for rating the one or more challenges. The social media application may be configured to allow the at least one second user to provide a feedback of the one or more challenges. The one or more challenges may comprise: an image preview, a highest score, and one or more comments. The one or more challenges may be selected from the group of challenges consisting of: a trivia game, an educational game, and a word game.

Another embodiment may be a method for an asynchronous multiplayer gameplay, comprising: providing a first computer, at least one second computer, and at least one server; wherein the first computer comprises a social media application for a first user; wherein the at least one second computer comprises the social media application for at least one second user; wherein the social media application is configured to allow the first user to be followed by the at least one second user; creating one or more challenges on the social media application by the first user; wherein the one or more challenges are stored in the at least one server; transmitting a feed containing at least one of the one or more challenges to the at least one second computer by the at least one server; displaying the feed to the at least one second user by the social media application; wherein the one or more challenges are configured to receive one or more inputs from the at least one second user; receiving the one or more inputs from the at least one second user asynchronously by the social media application to create an input data; storing the input data into the at least one server; calculating one or more scores based on the input data; and displaying the one or more scores of the one or more challenges by the social media application. The one or more challenges may be one or more music video trivia questions that are part of a music video trivia game; and wherein the method may further comprise the steps of: playing one or more music videos of the music video trivia game; prompting the at least one second user to identify one or more facts about the one or more music videos; and displaying a correct answer of the music video trivia game. The input data may comprise a popularity data; and wherein the popularity data may be configured to indicate a popularity of the one or more music videos of the music video trivia game. The social media application may be configured to allow the at least one second user to provide one or more approvals for the one or more music videos; and wherein the one or more approvals of the one or more music videos may be aggregated to create a playlist of the one or more music videos. The calculation of each of the one or more scores may be inversely proportional to a time period lapsed to correctly answer the one or more challenges. Each of the one or more scores may be compared and displayed to the first user and the at least one second user. The method may further comprise: a rating system; wherein the rating system may be configured to solicit one or more ratings from the at least one user for rating the one or more challenges; and wherein the rating system may be configured to display an average rating of the one or more ratings. The social media application may be configured to allow the at least one second user to provide a feedback of the one or more challenges. The one or more challenges may comprise: an image preview, a highest score, and one or more comments.

Another embodiment may be a method for an asynchronous multiplayer gameplay, comprising: providing a first computer, at least one second computer, and at least one server; wherein the first computer comprises a social media application for a first user; wherein the at least one second computer comprises the social media application for at least one second user; wherein the social media application is configured to allow the first user to be followed by the at least one second user; creating one or more challenges on the social media application by the first user; wherein the one or more challenges are one or more music video trivia questions that are part of a music video trivia game and are stored in the at least one server; transmitting a feed containing at least one of the one or more challenges to the at least one second computer by the at least one server; displaying the feed to the at least one second user by the social media application; wherein the one or more challenges are configured to receive one or more inputs from the at least one second user; playing one or more music videos of the music video trivia game; prompting the at least one user to identify one or more facts about the one or more music videos; receiving the one or more inputs from the at least one second user asynchronously by the social media application to create an input data; wherein the input data comprises a popularity data configured to indicate a popularity of the one or more music videos of the music video trivia game; displaying a correct answer of the music video trivia game; storing the input data into the at least one server; calculating one or more scores based on the input data; wherein the calculation of each of the one or more scores is inversely proportional to a time period lapsed to correctly answer the one or more challenges; displaying the one or more scores of the one or more challenges by the social media application; wherein each of the one or more scores are compared and displayed to the first user and the at least one second user; wherein the social media application is configured to allow the at least one second user to provide one or more approvals for the one or more music videos; wherein the one or more approvals of the one or more music videos are aggregated to create a playlist of the one or more music videos; wherein the social media application comprises a rating system; wherein the rating system is configured to solicit one or more ratings from the at least one second user for rating the one or more challenges; and wherein the social media application is configured to allow the at least one second user to provide a feedback of the one or more challenges.

Existing games are generally played between two players. Thus, in one embodiment, the method may provide a gameplay that invites an infinite number of players.

Existing systems that are configured for gameplay among many players (e.g., massively multiplayer online games) generally require simultaneous play in order to achieve meaningful interaction among players and/or between a player and the game. These gaming systems are often based in one “world” or stage a timed tournament that ends concurrently for all players. Thus, in one embodiment, the method may provide a gameplay for a large number of players without the restriction of simultaneous play or timed tournament setting.

Existing social feeds display/share text, photos, and/or videos and generally do not feature games that display scores for achievement within that game. Additionally, accumulating Facebook® “likes” or Twitter® “favorites” is not equivalent to scoring within a game. Thus, in one embodiment, the method may provide an online game that obtains user approvals for particular challenge or game.

Online games are generally not open to non-players—that is, there typically are not spectators viewing the actual game. There exist special events or broadcasts of games, but, the games themselves generally do not have an inherent broadcast mechanism. Thus, in one embodiment, the method may provide an online gameplay platform that provides game availability to spectators within the game. These spectator users may choose to follow users within the game and may see the followed users' games unfold.

Existing games generally do not allow for opponent feedback other than moves within the game and chat messages. Thus, in one embodiment, the method may provide an online game that requests a rating from a user upon completing a challenge, so that the user may judge the challenge on a scale of 0.0 to 10.0. Each challenge on the feed may display an average rating and may allow users to comment on challenges and engage with other comments.

In one embodiment, the method may provide asynchronous multiplayer gameplay, which may be used for a variety of games. For example, another embodiment of the method may be applied to games such as trivia games (e.g., music video trivia game), word search games, educational games (e.g., math games), and tic-tac-toe games.

In one embodiment, the method may facilitate the meetings of other users who share similar tastes and interests.

In one embodiment, the method may allow the users to see what music videos are popular among their peers. Comments and ratings of the videos may be provided to give users context about a particular music videos' popularity.

In one embodiment, the method may provide data on a music videos' popularity in terms of frequency in challenges, time spent answering questions, proportion of users getting each question correct about the video, ratings of the video, “approvals” the music video garners, numbers of comments onto challenges featuring the video, and plays of the video outside the challenge.

In one embodiment, the method may provide users to include an unlimited amount of players in a game (i.e., by having a user post challenges to his or her followers and building relationships within the game).

In one embodiment, the method may allow users to opt into as many games as they want by following other users.

In one embodiment, the method may allow users to create challenges themselves.

In one embodiment, the method may provide a platform for cultivating social relationships with users based solely on their activity within the system.

It is an object to overcome the deficiencies of current online games.

Additional embodiments will be understood from the following detailed description of the invention.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a flow chart of one embodiment of the method for an asynchronous multiplayer gameplay.

FIG. 2 is a block diagram of one embodiment of a computer.

FIG. 3 is a flow diagram of one embodiment of a system for an asynchronous multiplayer gameplay.

FIG. 4 is an illustration of one embodiment of the second computer with the social media application and shows one embodiment of the challenge screen, showing a challenge.

FIG. 5 is an illustration of another embodiment of the second computer with the social media application and shows one embodiment of the feed screen, showing a feed.

FIG. 6 is a screenshot of another embodiment of the social media application and shows one embodiment of the results screen.

### DETAILED DESCRIPTION OF THE INVENTION

In the following detailed description of various embodiments of the computer-based method, numerous specific details are set forth in order to provide a thorough understanding of various aspects of one or more embodiments. However, one or more embodiments of the method may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present method will become apparent to those skilled in the art from the following detailed description, which shows and describes illustrative embodiments of the method. As will be realized, the invention is capable of modifications in various obvious aspects, all without departing from the spirit and scope of the present disclosure. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, the terms “computer”, “computer system”, and “server” may refer to any device that processes information with an integrated circuit chip, including without limitation, mainframe computers, work stations, servers, desktop computers, portable computers, laptop computers, embedded computers, wireless devices including cellular phones, smart phones, tablet computers, personal digital assistants, digital media players, portable game players, and hand-held computers.

As used herein, the term “Internet” may refer to any collection of networks that utilizes standard protocols, whether Ethernet, Token ring, Wi-Fi, asynchronous transfer mode (ATM), Fiber Distributed Data Interface (FDDI), code division multiple access (CDMA), global systems for mobile communications (GSM), long term evolution (LTE), or any combination thereof.

As used herein, the terms “application”, “software”, and “software application” generally refer to any set of machine-readable instructions on a client machine, web interface, and/or computer, downloadable or externally hosted, which directs a computer's processor to perform specific steps, processes, or operations disclosed herein.

The following discloses a method for an asynchronous group play or asynchronous multiplayer gameplay. In an embodiment, a user selects the image for a challenge, and the user may see a screen where he or she plays the challenge. During the game, the user may see a music video with a prompt or question and answer choices. To complete the game, the user may select his or her chosen answer, and the challenge may then displays the results to the user.

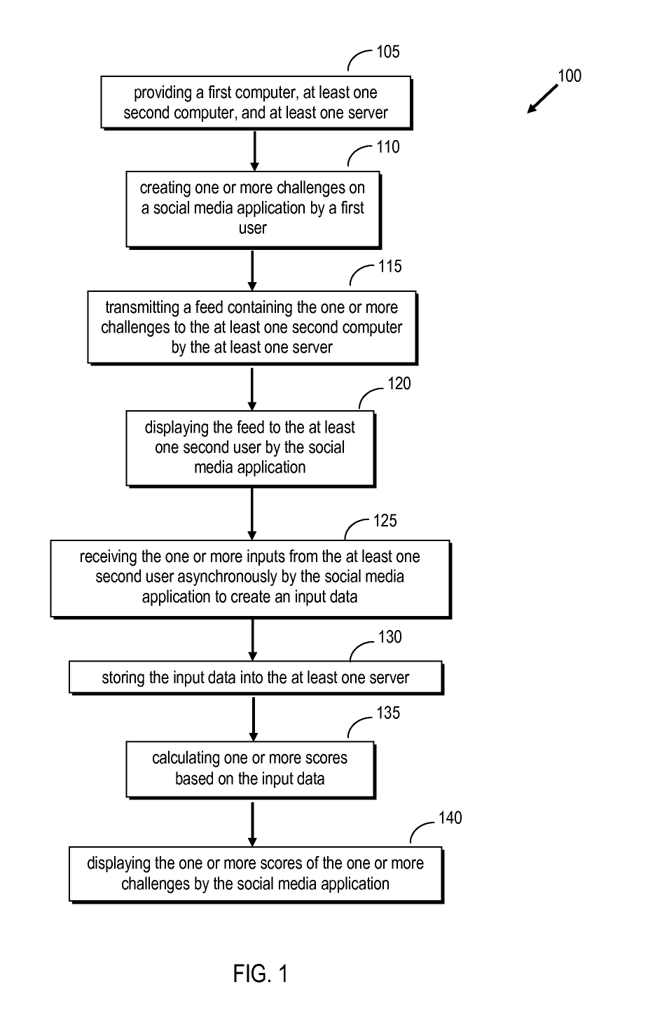

FIG. 1 is a flow chart of one embodiment of the method for an asynchronous multiplayer gameplay. As shown in FIG. 1, one embodiment of the method 100 may comprise the steps of: providing a first computer, at least one second computer, and at least one server 105; creating one or more challenges on a social media application by a first user 110; transmitting a feed containing the one or more challenges to the at least one second computer by the at least one server 115; displaying the feed to the at least one second user by the social media application 120; receiving the one or more inputs from the at least one second user asynchronously by the social media application to create an input data 125; storing the input data into the at least one server 130; calculating one or more scores based on the input data 135; and displaying the one or more scores of the one or more challenges by the social media application 140.

FIG. 1 shows the first step of the method 100, which may be providing a first computer, at least one second computer, and at least one server 105. As discussed above, a computer generally refers to any device with a processor that processes information with an integrated circuit chip, including without limitation, a desktop computer, laptop, tablet computer, smartphone, or the like. Both the first computer and second computer are generally configured with a social media application, which is generally a software program or any computer readable instructions that causes the processor to perform the methods and processes disclosed herein when the instructions are executed by the processor.

The social media application may be configured to communicate with the server via a network such as the Internet, such that the social media application transmits and receives data/content to and from the server. The social media application may also be configured to allow a user to create challenges in the computer. The social media application may have a user interface configured to receive or obtain one or more user inputs or parameters and may be configured receive content from the server and convert such content into a feed, which may be displayed the computer. Additionally, the social media application may be configured to run any media content such as audio, video, and image files and may comprise user account information such as username and password. In a preferred embodiment, the social media application may allow two or more users to communicate with each other and may allow the first user to be followed by the second user.

The server may be any programmed suitable computer hardware system that receives and responds to requests across a computer network to provide, or help to provide, the transmission of content to one or more computers. In one embodiment, the server generally transmits content to the social media applications of those computers, and the social media applications may convert the content into a feed containing challenges created by the first user.

FIG. 1 also shows the second step of the method 100, which may be creating one or more challenges on a social media application by a first user 110. When a first user is utilizing the social media application, the social media application may prompt the first user to create a challenge. In response, the first user may create one or more challenges that may be stored in the server. A challenge generally refers to any invitation by the first user to engage in a contest, trivia, or competition and may be a game object that is playable by one or more users. The challenge may have a scoring scheme, and the users of the social media application may expect to be scored and then be made aware of the results. In various embodiments, the challenge may be a trivia game, an educational game, and/or a word game. For example, in one embodiment, the challenge may be a music trivia game, in which the social media application may play one or more music videos (or portions of the videos) and prompt another user (i.e., second user) to identify one or more facts about the music videos. After playing the videos and prompting the second user to identify the facts about the music video, the second user may enter his or her input in response to the music video trivia question. The social media application may then display the correct answer of the music video trivia game with or without an indication as to whether the second user's answer was correct.

The first user may create a challenge by selecting a music video and creating a plurality of multiple choice answers, in which the second user would be select one of the answers and simultaneously accept the challenge. Once created, the challenge may be stored in the server.

FIG. 1 shows the third and fourth steps of the method 100, which may be transmitting a feed containing the one or more challenges to the at least one second computer by the at least one server 115 and displaying the feed to the at least one second user by the social media application 120. The feed may be any wireless or hardwire transmission or conveyance by the server via satellite, Internet, or by broadcast over one or more networks. The feed may contain one or more challenges, and each user of the social media application may have a feed of challenges posted by the users he or she follows. These challenges may be displayed in reverse chronological order, but may be sorted in any order such as according to user's name, score, comments, or other criteria. The feed may also be searchable and displayed as a result to a search. For each challenge, the feed may display the user who posted the challenge, an image for the challenge, a button to play the challenge, the name of the user with the highest score along with the highest score, the latest comments, the number of comments, and a link to a screen where the user may see greater detail and post a comment. Generally, each challenge may be configured to receive one or more inputs from the second user. The server may then transmit the feed to the second computer used by the second user, and the feed may be displayed to the second user by the social media application. Once the feed is displayed, the second user may select a particular challenge asynchronously or any given time period by browsing through the feed and selecting a particular challenge.

FIG. 1 shows the fifth and sixth steps of the method 100, which may be, receiving the one or more inputs from the at least one second user asynchronously by the social media application to create an input data 125 and storing the input data into the at least one server 130. Once the second user selects a challenge, the user may be prompted to answer the challenge. This may entail having the user to provide one or more inputs to the social media application, in response to the challenge. After providing a user input, the social media application receives the input from the user and creates an input data. The input data may then be stored in the server. Additionally, data relating to a users' performance in challenges may be processed and subsequently displayed on each of the user's profiles, so that a user may be matched with other users to play games and/or follow each other.

FIG. 1 also shows the seventh and eighth steps of the method 100, which may be calculating one or more scores based on the input data 135 and displaying the one or more scores of the one or more challenges by the social media application 140. When utilizing the input data stored in the server, the social media application may analyze the input data and convert the input data into a score. The score may be graded from 0 to 100 or from any alphanumerical character (e.g., A+, A, A−, B+, B, B−). After calculating the scores, the scores may be displayed to the first user and/or second user.

Although FIG. 1 shows only eight steps, it should be understood that any number of steps may be used, and that some steps may be performed at the same time or out of order.

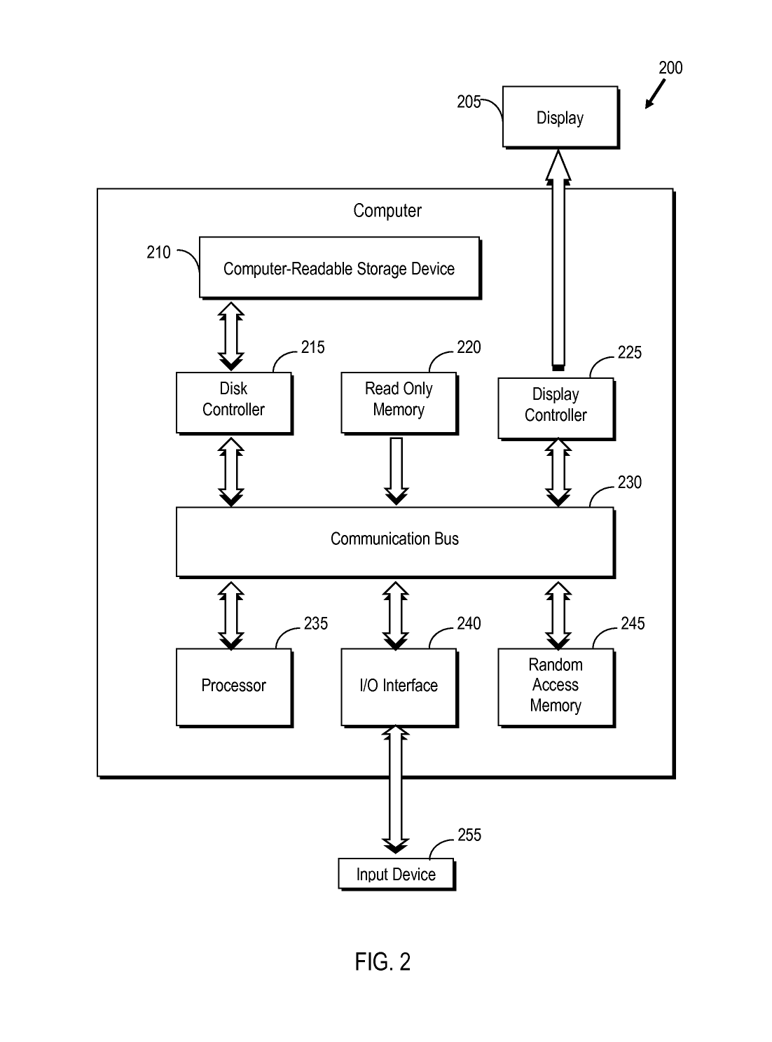

FIG. 2 is a block diagram of one embodiment of a computer. As shown in FIG. 2, one embodiment of a computer 200 may comprise: a display 205; computer-readable storage device 210; disk controller 215; read only memory (ROM) 220; display controller 225; communication bus 230; processor 235; input/output interface (I/O interface) 240; random access memory (RAM) 245; and one or more input devices 255. In various embodiments, the computer 200 may be a personal computer or mobile computing device that comprises a processor 235 connected through a communication bus 230, which may connect to other various electronic hardware, including without limitation, a display controller 225, RAM 245; ROM 220; disk controller 215; and I/O interface 240. The disk controller 215 may be configured to control the computer-readable storage device 210, which may be a hard drive, optical disk drive, or another form of computer memory. The display controller 225 is generally connected to the display 205 such as a liquid crystal display (LCD), projection system, or touchscreen. The computer 200 may also have at least one display screen to display the search results to a user and may include, without limitation, an liquid crystal display (LCD), cathode ray tube (CRT), light emitting diode (LED), and the like. The I/O interface 240 may be connected to one or more input devices 255 such as a keyboard and/or mouse.

The processor 235 may be configured to execute a set of computer readable instructions and further to execute one or more applications or computer program such as the social media application. In other various embodiments, the computer readable instructions or application may be tangibly embodied in the memory of the computer such as the RAM 245 or ROM 220, or on a computer-readable storage medium, such as a magnetic, optical or solid-state digital storage medium. The computer 200 may also include other components without deviating from the scope of the invention.

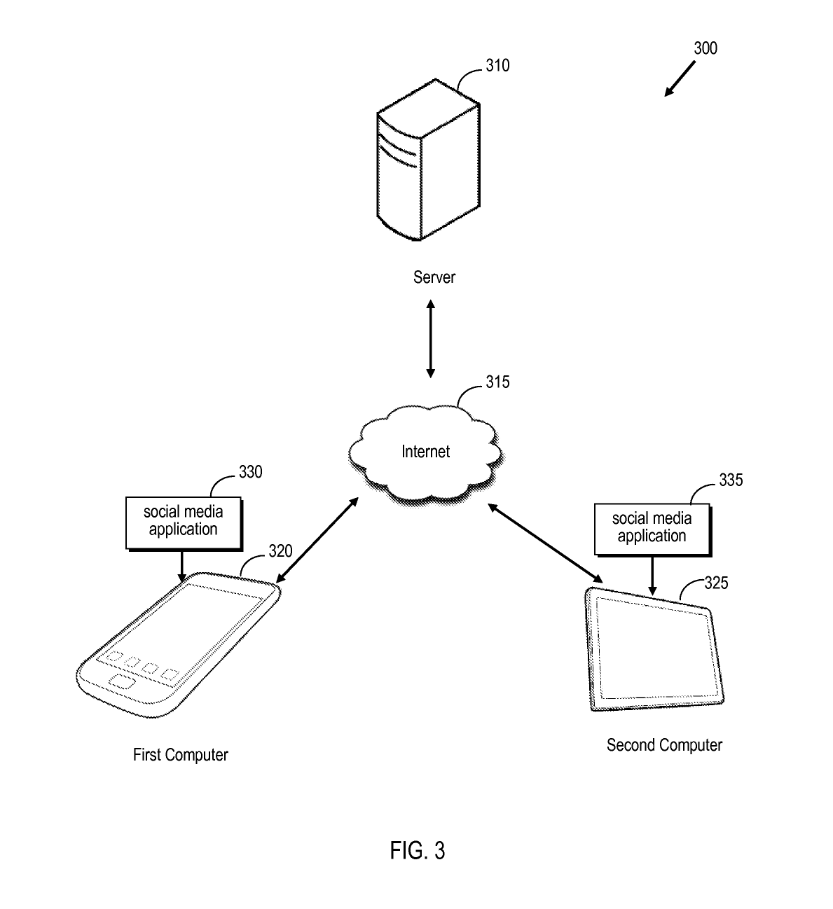

FIG. 3 is a flow diagram of one embodiment of a system for an asynchronous multiplayer gameplay. As shown in FIG. 3, an embodiment of the system 300 for an asynchronous multiplayer gameplay may comprise: a server 310; Internet 315; first computer 320; second computer 325; and social media applications 330, 335. As discussed above, the server 305 may be another computer, database, or hardware system that manages access to a centralized resource or service in a network. The server may store challenges and transmit feeds to the social media applications 330, 335 containing such challenges. The Internet 315 may be a computer network comprising of a worldwide network of computer networks that generally use TCP/IP networking protocols to facilitate data transmission and exchange. The first computer 320 and second computer 325 may be any computing device designed for individual use such as browsing the Internet 315 or World Wide Web, and may comprise one or more software applications such as a social media application 330, 335 for asynchronous multiplayer gameplay.

FIG. 3 also shows how the system 300 may be performed. Specifically, a first user utilizing the social media application 330 may create one or more challenges with the first computer 320. Once created, the challenge may be stored in the server 310 and later transmitted to a second computer 325 by the server 310 via a feed containing one or more challenges. The challenges may be displayed to a second user via the social media application 335 of a second computer 325, and the second user may provide one or more inputs in response to the challenge, wherein the inputs become input data, which may also be stored in the server 310. The social media application 335 may also display the correct answer to the second user. Using the input data, the server 310 or social media application 330, 335 may calculate the scores, and the scores may then be compared and displayed to users of the social media application 330, 335. The scores may be generally a numerical assessment of a user's performance in a challenge and may be inversely proportional to the time it takes the user to answer the challenge correctly.

The social media application 330, 335 may also comprise a rating system, which may be configured to solicit ratings from a second user. The rating system may display an average rating for each challenge and may display the total number of ratings. Additionally, the second user may also provide feedback of the challenge by providing comments or approvals for each challenge.

Although FIG. 3 shows a smartphone as the first computer 320 and tablet as the second computer 325, any type of computer or electronic device may be used such as a desktop computer, laptop, or any other streaming device. Additionally, although FIG. 3 only shows two users, it should be understood that any number of users may utilize the method 100 of the asynchronous multiplayer gameplay.

In a preferred embodiment, the challenge may be a music video trivia game, but any type of challenge may be created such as trivia questions, contests, educational games, and word games. For example, assuming that the challenge is a music video trivia game, the social media application 330, 335 may play one or more music videos. In response to the music video, the second user may provide an answer to the music video trivia game challenge by attempting to identify facts about the music video. The social media application 330, 335 may receive an input from the second user, and the input may become input data, which is generally stored in the server 310. The input data may also comprise other forms of data such as popularity data, which usually indicates a popularity of a particular music video. After receiving an input from the second user, the social media application 330, 335 may display a correct answer of the music video trivia game. The first user or second user may also provide one or more approvals for the music videos, similar to Facebook® likes or Twitter® “favorites”. In one embodiment, the approval may be embodied as a heart icon that users click to approve a music video, and a user's approval video may show up on a playlist within the social media application. The approvals of the music videos may then be used to aggregate the music videos into a list such as a playlist.

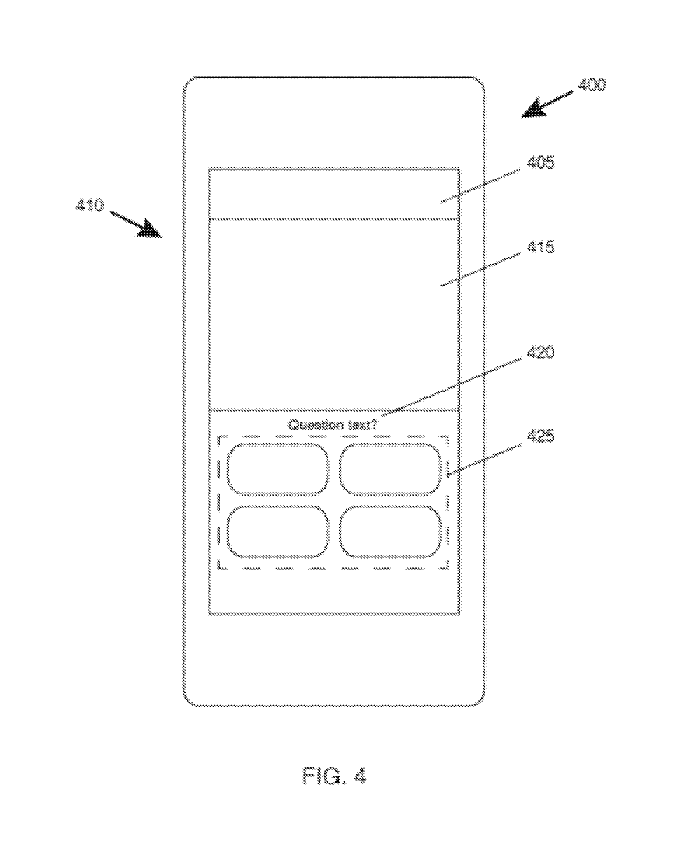

FIG. 4 is an illustration of one embodiment of the second computer with the social media application and shows one embodiment of the challenge screen, showing a challenge. As shown in FIG. 4, one embodiment of the second computer 400 with the social media application 405 may comprise: a challenge screen 410 of a music trivia game. The challenge screen 410 may comprise: a music video 415, prompt 420, and answer choices 425. FIG. 4 shows that the social media application 405 may display a challenge screen, which may play a music video 415, and provide a prompt 420 or question for the second user to answer the challenge. Specifically, the prompt 420 may ask the second user to identify one or more facts about the music video, and the second user, in response, may then provide an answer to the music video by selecting the correct answer from the answer choices 425. After receiving the input from the second user, the correct answer may be displayed to the second user. Although FIG. 4 shows the challenge screen with only one music video and one prompt or question, each challenge screen may contain more than one question or prompt and may contain more than one music video.

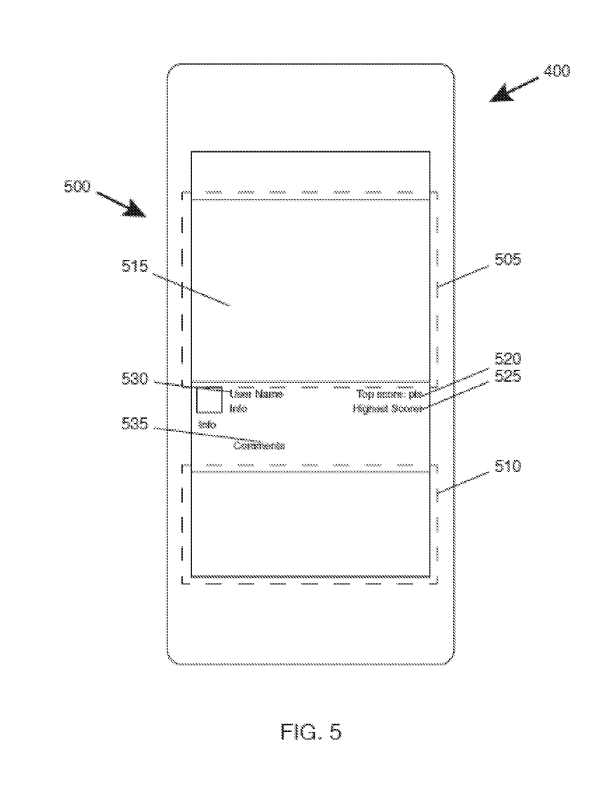

FIG. 5 is an illustration of another embodiment of the second computer with the social media application and shows one embodiment of the feed screen, showing a feed. As shown in FIG. 5, one embodiment of second computer 400 with the social media application 405 may comprise: a feed screen 500 of a music trivia game, wherein the feed screen 500 may comprise one or more challenges 505, 510. A challenge 505 may further comprise: an image preview 515, highest score 520, name of user with the highest score 525, username 530, and comment section 535. As discussed above, a feed may be transmitted by the server to the second computer 400 and displayed as a feed screen 500 in the social media application 405 of the second computer 400. Once displayed, the second user may select a challenge from the feed screen 500. In the feed screen 500, an image preview 515 of each challenge 505, 510 may be displayed and may be an image of a music video. The highest score 520 achieved by the user and the name of that user may also be displayed in each challenge 505, 510. Furthermore, a user may provide comments about the challenge in the comment section 535 in order to provide feedback about the social media application 405. Each comment may be a text post that a user posts to a challenge, and it may contain alphanumeric characters, emoji, hyperlinks, and/or non-English characters.

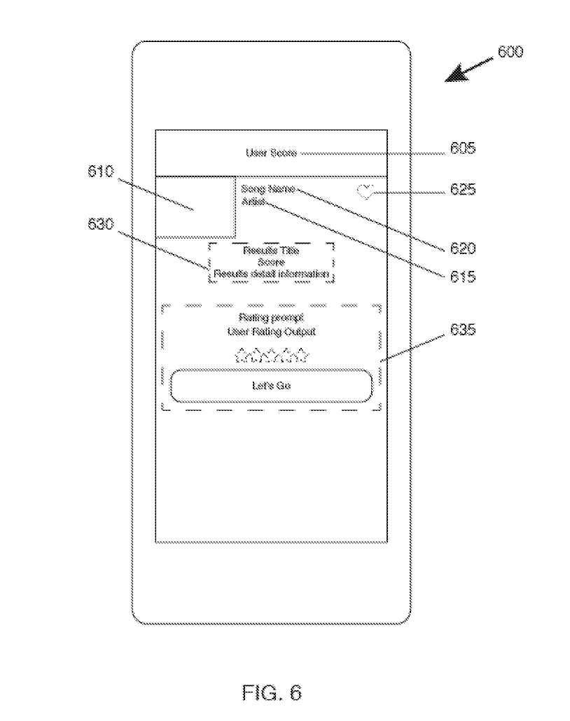

FIG. 6 is a screenshot of another embodiment of the social media application and shows one embodiment of the results screen. As shown in FIG. 6, one embodiment of the results screen 600 of the social media application may comprise: a score 605, image preview 610, artist name 615, title of song 620, approval button 625, notification 630, and rating system 635. The results screen 600 typically appears after the second user has answered the challenge and may show a user a score 605 for answering that particular challenge. The results screen 600 may also show the image preview 610, which is generally a scaled image of the challenge such as an image of the music video. The results screen 600 may also show the artist name 615 and title of the song 620. The approval button 625 is generally configured to allow a user to approve a challenge, similar to a Facebook® “like” or Twitter® “favorite”. The notification 630 may be any message to inform the user about the response inputted by the user. For example, as shown in FIG. 6, the notification 630 may display that the user scored correctly and may show the amount of points that the user has earned. The notification 630 may also show the user's current streak with respect to the challenges. The rating system 635 may be configured to solicit ratings from a user for rating the challenges. To adjust and select a rating, a user may select the amount of stars and select an accept button (e.g., “Let's Go” button, as shown in FIG. 6). The rating may be a number approximately between 0.0 and 10.0 that a user assigns to a challenge and may allow users to rate another user's challenges. The rating system 635 may also be configured to display an average rating of the total ratings submitted. In various embodiments, the rating system may comprise a share button, in which a user may post the results to a social media website, text, or email.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A method for an asynchronous multiplayer gameplay, comprising:
providing at least one server and a social media application;
wherein said social media application is configured to run on a first computer and at least one second computer;
wherein said social media application is configured to allow a first user to be followed by a at least one second user;
prompting said first user to create one or more challenges on said social media application;
wherein said one or more challenges are stored in said at least one server;
transmitting a feed containing at least one of said one or more challenges to said at least one second computer by said at least one server;
displaying said feed to said at least one second user by said social media application;
wherein said one or more challenges are configured to receive one or more inputs from said at least one second user;
receiving said one or more inputs from said at least one second user asynchronously by said social media application to create an input data;
storing said input data into said at least one server; and
calculating one or more scores based on said input data.

2. The method according to claim 1, wherein said one or more challenges are one or more music video trivia questions that are part of a music video trivia game.

3. The method according to claim 2, wherein said input data comprises a popularity data; and
wherein said popularity data is configured to indicate a popularity of said one or more music videos of said music video trivia game.

4. The method according to claim 2, wherein said social media application is configured to allow said at least one second user to provide one or more approvals for said one or more music videos.

5. The method according to claim 1, wherein said calculation of each of said one or more scores is inversely proportional to a time period lapsed to correctly answer said one or more challenges.

6. The method according to claim 1, wherein each of said one or more scores are compared and transmitted to said first user and said at least one second user.

7. The method according to claim 1, further comprising:
a rating system;
wherein said rating system is configured to solicit one or more ratings from said at least one second user for rating said one or more challenges.

8. The method according to claim 1, wherein said social media application is configured to allow said at least one second user to provide a feedback of said one or more challenges.

9. The method according to claim 1, wherein said one or more challenges comprise: an image preview, a highest score, and one or more comments.

10. The method according to claim 1, wherein said one or more challenges are selected from the group of challenges consisting of: a trivia game, an educational game, and a word game.

11. A method for an asynchronous multiplayer gameplay, comprising:
providing at least one server and a social media application;
wherein said social media application is configured to run on a first computer and at least one second computer;
wherein said social media application is configured to allow said first user to be followed by said at least one second user;
prompting said first user to create one or more challenges on said social media application;
wherein said one or more challenges are stored in said at least one server;
transmitting a feed containing at least one of said one or more challenges to said at least one second computer by said at least one server;
displaying said feed to said at least one second user by said social media application;
wherein said one or more challenges are configured to receive one or more inputs from said at least one second user;
receiving said one or more inputs from said at least one second user asynchronously by said social media application to create an input data;
storing said input data into said at least one server;
calculating one or more scores based on said input data; and
displaying said one or more scores of said one or more challenges by said social media application.

12. The method according to claim 11, wherein said one or more challenges are one or more music video trivia questions that are part of a music video trivia game; and
wherein said method further comprises the steps of:
playing one or more music videos of said music video trivia game;
prompting said at least one second user to identify one or more facts about said one or more music videos; and
transmitting a correct answer of said music video trivia game.

13. The method according to claim 12, wherein said input data comprises a popularity data; and
wherein said popularity data is configured to indicate a popularity of said one or more music videos of said music video trivia game.

14. The method according to claim 13, wherein said social media application is configured to allow said at least one second user to provide one or more approvals for said one or more music videos; and
wherein said one or more approvals of said one or more music videos are aggregated to create a playlist of said one or more music videos.

15. The method according to claim 14, wherein said calculation of each of said one or more scores is inversely proportional to a time period lapsed to correctly answer said one or more challenges.

16. The method according to claim 15, wherein each of said one or more scores are compared and transmitted to said first user and said at least one second user.

17. The method according to claim 16, further comprising:
a rating system;
wherein said rating system is configured to solicit one or more ratings from said at least one user for rating said one or more challenges; and
wherein said rating system is configured to display an average rating of said one or more ratings.

18. The method according to claim 17, wherein said social media application is configured to allow said at least one second user to provide a feedback of said one or more challenges.

19. The method according to claim 18, wherein said one or more challenges comprise: an image preview, a highest score, and one or more comments.

20. A method for an asynchronous multiplayer gameplay, comprising:
providing at least one server and a social media application;
wherein said social media application is configured to run on a first computer and at least one second computer;
wherein said social media application is configured to allow said first user to be followed by said at least one second user;
prompting said first user to create one or more challenges on said social media application;
wherein said one or more challenges are one or more music video trivia questions that are part of a music video trivia game and are stored in said at least one server;
transmitting a feed containing at least one of said one or more challenges to said at least one second computer by said at least one server;
transmitting said feed to said at least one second user by said social media application;
wherein said one or more challenges are configured to receive one or more inputs from said at least one second user;
playing one or more music videos of said music video trivia game;
prompting said at least one user to identify one or more facts about said one or more music videos;
receiving said one or more inputs from said at least one second user asynchronously by said social media application to create an input data;
wherein said input data comprises a popularity data configured to indicate a popularity of said one or more music videos of said music video trivia game;
transmitting a correct answer of said music video trivia game;
storing said input data into said at least one server;
calculating one or more scores based on said input data;
wherein said calculation of each of said one or more scores is inversely proportional to a time period lapsed to correctly answer said one or more challenges;
transmitting said one or more scores of said one or more challenges by said social media application;
wherein each of said one or more scores are compared and transmitted to said first user and said at least one second user;
wherein said social media application is configured to allow said at least one second user to provide one or more approvals for said one or more music videos;
wherein said one or more approvals of said one or more music videos are aggregated to create a playlist of said one or more music videos;
wherein said social media application comprises a rating system;
wherein said rating system is configured to solicit one or more ratings from said at least one second user for rating said one or more challenges; and
wherein said social media application is configured to allow said at least one second user to provide a feedback of said one or more challenges.
